(19) United States
(12) Patent Application Publication
(10) Pub. No.: US 2009/0084226 A1
(43) Pub. Date: Apr. 2, 2009

(54) INTERMEDIATE BULK CONTAINER (IBC) TOTE WRENCH

(76) Inventor: Jimmy Miley, Breckenridge, TX (US)

Correspondence Address: MICHAEL RIES, 318 PARKER PLACE, OSWEGO, IL, 60543, US

(21) Appl. No.: 12/324,935

(22) Filed: Nov. 28, 2008

Related U.S. Application Data
(63) Continuation of application No. 11/866,389, filed on Oct. 2, 2007, now abandoned.

(51) Int. Cl. B67B 7/14

(52) U.S. Cl. 81/3.44

(57) ABSTRACT

Disclosed is a wrench for tightening or removing caps on containers. More specifically a wrench to tighten or remove a tote cover. Disclosed is a combination tote cover wrench that has accommodations for a torque wrench. Also disclosed is just a tote cover wrench.

This application is a continuation of U.S. patent application Ser. No. 11/866,389, filed Oct. 2, 2007 which has a priority date of Oct. 4, 2006, the entire disclosure of which is incorporated by reference.

### TECHNICAL FIELD & BACKGROUND

The present invention generally relates to the field of tools to loosen and tighten lids, IBC caps, caps from IBC containers. More specifically, the present invention relates to a wrench to open or close lids on intermediate bulk container (IBC) totes.

More often than not, workers are unable to quickly and efficiently open or close lids on Intermediate Bulk Container totes. It is also difficult to torque the lids down for transport per Department of Transportation (DOT) safety regulations. Currently, frustrated workers rely on the inefficient and dangerous method of beating on the lids with a hammer, often causing damage to either a persons hands or the approximately $18 apiece tote lids. In addition, some chemicals cause the lids to stick and the sun's heat can melt plastic lids, welding them shut.

The present invention is a combination tote wrench that aids in opening and closing the lids on Intermediate Bulk Containers totes as well as torque these lids to the Department of Transportation regulatory psi standards for safety in transportation.

The present invention is a tool that is used to easily open close and torque down IBC Totes. The present invention may be constructed from rectangular 14 gauge tubing that measures 1″ by 2″, the wrench may be available in three options: combination, which measures 18″ long. The Combination Quick Tote Wrench has two ⅛ channel irons that measure 2.5″ by 0.2″. While they can be constructed to fit varying sized caps, currently the C channels on the Combination and Heavy Duty models are centered to fit an cap that may be eight or six inches and welded to the unit. All options utilize a 0.5″ bolt with a 0.75″ hexagonal head for ease when torquing tote lids to meet DOT standards and have a 2.25″ stainless steel key ring attachment.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a wrench, in accordance with one embodiment of the present invention;

FIG. 2 illustrates a drawing of a side view of a wrench, in accordance with one embodiment of the present invention;

FIG. 2a illustrates a drawing of a side view of a wrench, in accordance with one embodiment of the present invention;

FIG. 2b illustrates a drawing of two end views of a wrench, in accordance with one embodiment of the present invention;

FIG. 2c illustrates a drawing of a top view of a wrench, in accordance with one embodiment of the present invention; and

FIG. 3 illustrates a drawing of a wrench, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

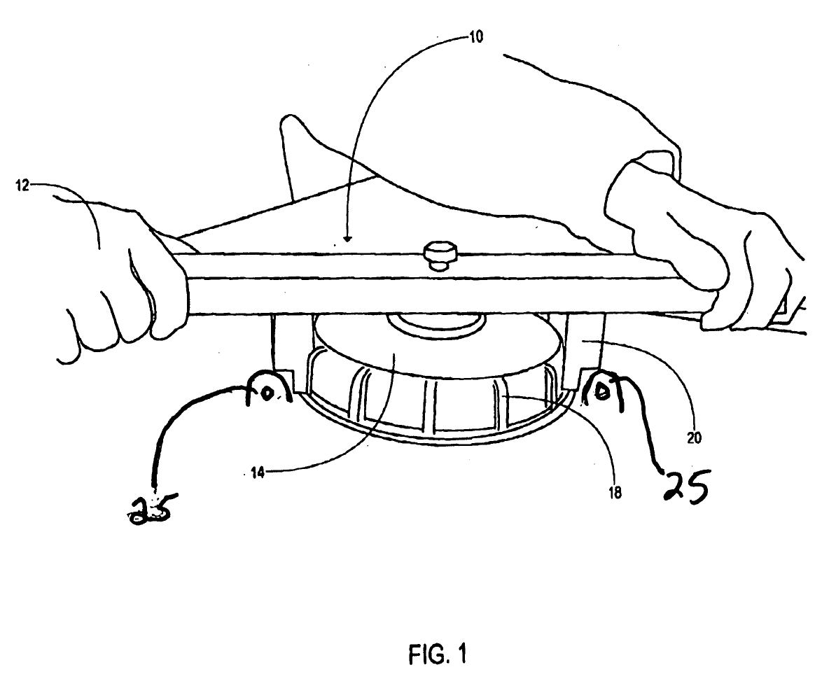

Referring now to FIG. 1, illustrated is a wrench 10 with a user 12 applying the wrench 10 to a tote cover 14. Tote cover 14 has a plurality of ridges 18 that come into contact with at least two channel irons 20. Wrench 10 may have two channel irons 20 that are positioned to accept the tote cover 14 in between. The user 12 will apply either a clockwise or counter clockwise force to the wrench 10 to open and remove tote cover 14 or to tighten down tote cover 14. Channel iron 20 will come into contact with the ridge 18. Shown is tote tab or tie down ear 25 that channel iron 20 must miss to operator properly to spin three hundred and sixty degrees.

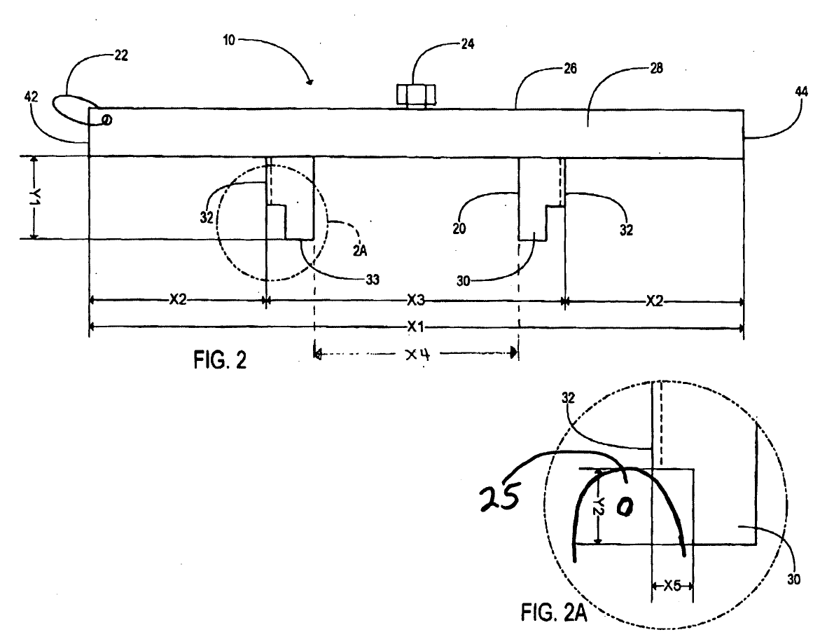

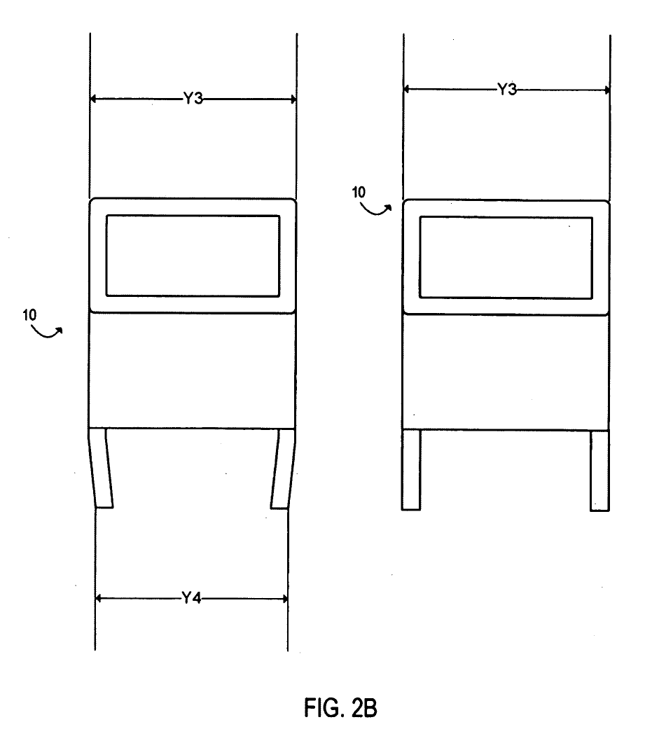

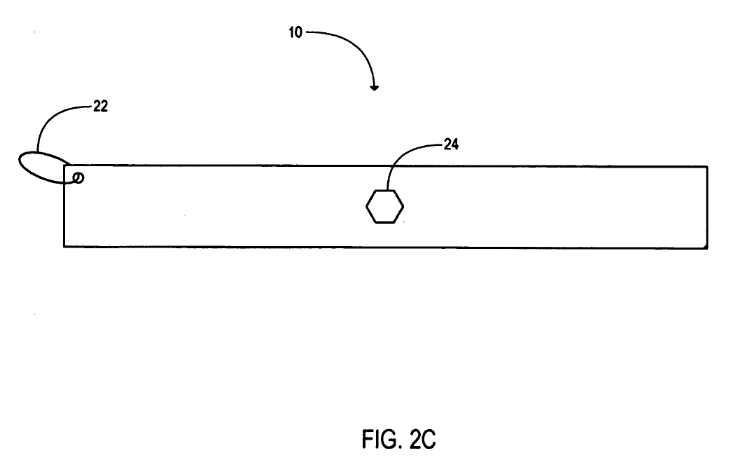

Referring to FIGS. 2 and 2a, illustrated is a side view of one embodiment of the wrench 10. Shown is a key ring 22 that may be made out of stainless seal. A hex head 24 is connected to the top surface 26 of a main body 28 of wrench 10 and located at a center point of the wrench 10. The Hex head bolt 24 is used to toque tote cover 14 to a specified torque requirement. Hex head bolt 24 may be 0.75 inch hex stock or a bolt. The channel iron 20 has a first channel iron tab 30 and a second channel iron tab 33 that extends from a channel iron back 32. The first channel iron tab 30 may extend a channel iron tab distance Y2 from a channel iron back 32 and offset an channel iron tab offset distance X5. The channel iron tab distance Y2 may be 0.625 inch and the channel iron tab offset distance X5 may be 0.375 inch. Shown is tote tab 25 that channel iron 20 must miss to operator properly. The channel iron tab distance Y2 and the channel iron tab offset distance X5 create a notch 33 that allows the tote tab 25 to avoid blocking the wrench from spinning 360 degrees.

In FIGS. 2 and 2a, as in one embodiment the channel iron 20 has a channel iron length Y1 that may be 2.125 inches. The main body 28 has a main body length X1 that may be 18 inches. The wrench 10 has a first wrench end 42 and a second wrench end 44. The channel iron 20 is positioned a wrench end distance X2 from either the first wrench end 42 and the second wrench end 44 that may be 4.75 inches. Channel irons 20 are a channel iron separation distance X3 that may be 8.5 inches. In FIG. 2b, as in one embodiment shown is an end view of wrench 10. Shown is a main body width Y3 that may be 2 inches and channel iron width Y4 that may be 1.9 inches or 2 inches. In FIG. 2b the left drawing shows channel irons 20 tapering into each other and the right drawing showing no taper. In FIG. 2c, as in one embodiment shown is a top view of wrench 10. Shown is key ring 22 and hex head 24. Shown is channel iron offset X4 that is the distance between a first channel iron tab 30 and a second channel iron tab 33. The channel irons 20 contact two ridges 18 to allow the wrench 10 to open the lid 14. On lids 14 that are six inches in diameter the channel iron offset X4 is in a range of 6.40 inch to 6.90 inches.

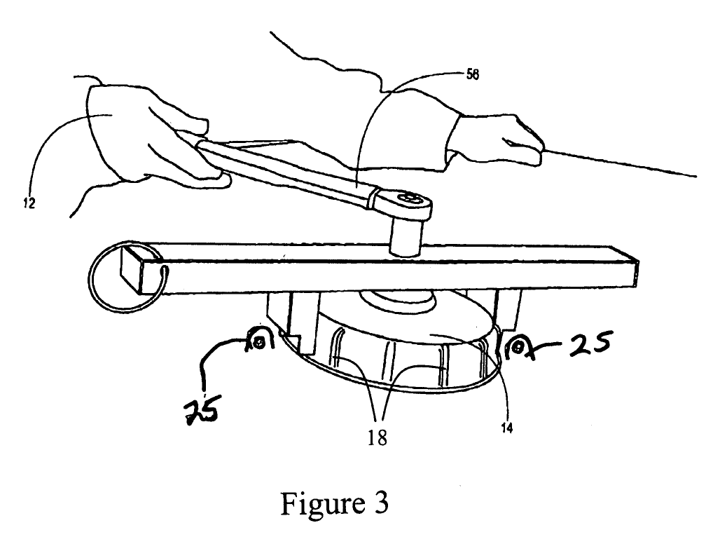

In FIG. 3, as in one embodiment the wrench 10 has torque wrench 56 connected to hex stock 24. This will allow user 12 to tighten the tote cover 14 to a specific torque value. Shown is tote tab 25 that channel iron 20 must miss to operator properly. Wrench 10 will turn a full 360 degrees when opening and closing the lid or tote cover 14. The tie down ears 25 are on both sides of lid 14 so that the lid 14 can be secured after having been tightened down with a zip tie passing through the tie down ears 25 and connecting to the lid 14. This secures the lids 14 in transportation down US highways preventing spills in case of an accident.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
a wrench with a main body having a top and bottom surface, two channel irons are connected to the bottom surface, the two channel irons accept a cover, a hex bolt is connected to the top surface.

2. The device of claim 1, wherein a key ring is attached to the main body.

3. The device of claim 1, wherein the hex bolt is from a selected one of hex stock and a hex bolt.

4. The device of claim 1 wherein the cover is a selected one of a tote cover and lid.

5. The device of claim 1, wherein the channel irons have a pair of tabs on each end so that they do not strike at least one tie down ear, the tie down ear is on a tote.

6. The device of claim 1, wherein a channel iron tab distance and a channel iron tab offset distance create a notch that allows a tote tab to avoid blocking the wrench from spinning 360 degrees.

7. The device of claim 1, wherein the wrench has a channel iron offset that is the distance between a first channel iron tab and a second channel iron tab, the channel irons contact at least two ridges on the lid to allow the wrench to open the lid, on lids that are six inches in diameter the channel iron offset is in a range of 6.40 inch to 6.90 inches.

8. A device comprising:
a wrench with a main body having a top and bottom surface, two channel irons are connected to the bottom surface, the two channel irons have a pair of tabs on each channel iron, the pair of tabs are a selected one of straight in shape and tapered into each other, a hex stock is connected to the top surface.

9. The device of claim 8, wherein a channel iron tab distance and a channel iron tab offset distance create a notch that allows a tote tab to avoid blocking the wrench from spinning 360 degrees.

10. The device of claim 8, wherein the wrench has a channel iron offset that is the distance between a first channel iron tab and a second channel iron tab, the channel irons contact at least two ridges on the lid to allow the wrench to open or close the lid by a clockwise or counterclockwise force that is transmitted through the channels irons to the at least two ridges causing the lid to open or close, on lids that are six inches in diameter the channel iron offset is in a range of 6.40 inch to 6.90 inches.

11. A method comprising:
placing two channel irons over a tote cover, the channel irons contacting the tote cover, the two channels connected to a wrench;
holding a main body with both hands of a user, the main body connected to the two channel irons, the main body is the backbone of the wrench;
applying a clockwise or counterclockwise force by the user with both hands to the wrench; and
removing or tightening the tote cover by the applied force.

12. The method of claim 11, wherein a key ring is attached to the main body.

13. The method of claim 11, wherein the hex bolt is from a selected one of hex stock and a hex bolt.

14. The method of claim 11, wherein the cover is a selected one of a tote cover and lid.

15. The method of claim 11, wherein the channel irons have a pair of tabs on each end, the pair of tabs have one half inch slots to accommodate at least one tie down ear, the at least one tie down ear is on all IBC containers.

16. The method of claim 11, wherein a channel iron tab distance and a channel iron tab offset distance create a notch that allows a tote tab to avoid blocking the wrench from spinning 360 degrees.

17. The method of claim 11, wherein the wrench has a channel iron offset that is the distance between a first channel iron tab and a second channel iron tab, the channel irons contact at least two ridges on the lid to allow the wrench to open the lid, on lids that are six inches in diameter the channel iron offset is in a range of 6.40 inch to 6.90 inches.
